(19) United States
(12) Patent Application Publication
(10) Pub. No.: US 2011/0199329 A1
(43) Pub. Date: Aug. 18, 2011

(54) CAPACITANCE CHANGE DETECTING CIRCUIT

(75) Inventors: Hidehito Kitakado, Osaka-shi (JP); Christopher Brown, Osaka (JP)

(73) Assignee: Sharp Kabushiki Kaisha, Osaka-shi, Osaka (JP)

(21) Appl. No.: 12/998,336

(22) PCT Filed: Jun. 2, 2009
(86) PCT No.: PCT/JP2009/060039

§ 371 Date: Apr. 8, 2011

(30) Foreign Application Priority Data
Nov. 14, 2008 (JP) 2008-291793

(51) Int. Cl. G06F 3/045

(52) U.S. Cl. 345/174

(57) ABSTRACT

When a surface of a liquid crystal panel is pressed, the capacitance value of a variable capacitor changes. In at least one embodiment, one electrode of the variable capacitor is connected to a voltage supply line to which a common voltage is applied, and the other electrode of the variable capacitor is connected to a gate electrode of a TFT. The TFT outputs a voltage generated according to the capacitance value of the variable capacitor. One electrode of a control capacitor is connected to the gate electrode of the TFT, and the other electrode of the control capacitor is connected to a control voltage line to which a control voltage is applied. By applying a control voltage to the gate electrode of the TFT through the control capacitor, while the load capacitance of the control voltage line is reduced and a change in capacitance is detected with a high sensitivity, the sensitivity can be adjusted according to the application, person, etc., when used. By this, a capacitance change detecting circuit is provided that can detect a change in capacitance with a high sensitivity and can control the sensitivity when used.

### TECHNICAL FIELD

The present invention relates to capacitance change detecting circuits that detect changes in electrostatic capacitance. The capacitance change detecting circuits of the present invention are formed in, for example, a display panel of an image display device, and are used in an application where a touch position on a display screen is detected, etc.

### BACKGROUND ART

In recent years, electronic devices that can be operated by touching a screen with a finger, a pen, etc., have become widely used. In addition, for a method of detecting a touch position on a display screen, a method is known in which a plurality of capacitance change detecting circuits are provided in a display panel to detect changes in electrostatic capacitance caused when a surface of the display panel is pressed with a finger, a pen, etc.

Patent Document 1 describes a liquid crystal display device including a capacitance change detecting circuit shown in FIG. 9. In the circuit shown in FIG. 9, when a surface of a liquid crystal panel is pressed, the capacitance value of a variable capacitor 91 changes, and correspondingly, a gate voltage of a TFT (Thin Film Transistor) 92 changes. Hence, a read current to be outputted from a source electrode of a TFT 93 when a high-level selection voltage Vsel is provided to a gate electrode of the TFT 93 changes according to the capacitance value of the variable capacitor 91. Therefore, by comparing an output voltage Vout outputted from the source electrode of the TFT 93 with a threshold value, it can be determined whether the liquid crystal panel has been pressed or not near the variable capacitor 91. Patent Document 1 also describes a capacitance change detecting circuit shown in FIG. 10. In the circuit shown in FIG. 10 is added a control wiring line connected to a gate electrode of a TFT 92, in order to apply a control voltage Vctrl to the gate electrode of the TFT 92.

Techniques related to the invention of the present application other than the above are described in Patent Documents 2 and 3. Patent Document 2 describes a method in which conductive protrusions are provided on a counter electrode of a display panel to detect an increase in leakage current flowing through a transistor when a counter substrate is pressed with a pen. Patent Document 3 describes a method in which a variable capacitor is formed by a pair of electrodes on substrates and a dielectric inserted between the electrodes, and by changing the electrical capacitance of the variable capacitor by physical or electrical force, an external input is detected.

### RELATED DOCUMENTS

### Patent Documents

[Patent Document 1] Japanese Laid-Open Patent Publication No. 2006-40289

[Patent Document 2] Japanese Laid-Open Patent Publication No. 9-80467

[Patent Document 3] Japanese Laid-Open Patent Publication No. 2004-295881

### SUMMARY OF THE INVENTION

### Problems to be Solved by the Invention

When pressing a surface of a display panel, there are, for example, the case of pressing with a finger and the case of pressing with a pen. The pressure applied to the display panel varies between these two cases. Also, the pressure applied to the display panel varies depending on the application, person, etc. Therefore, it is desirable for an image display device that detects a touch position on a display screen to be able to adjust the sensitivity when used. In addition, there are characteristic variations in TFTs in capacitance change detecting circuits, due to which the detection sensitivity varies. From this point of view, too, a sensitivity adjustment is required.

However, the circuit shown in FIG. 9 does not have a means of controlling the gate voltage of the TFT 92, and the gate voltage of the TFT 92 is determined by the variable capacitor 91 and the gate capacitance of the TFT 92 when designed. Hence, with the circuit shown in FIG. 9, the sensitivity cannot be adjusted when used.

In the circuit shown in FIG. 10, by changing the control voltage Vctrl, the sensitivity can be adjusted when used. However, in this circuit, a control wiring line is connected to capacitance change detecting circuits of one row in the liquid crystal panel. Since many gate electrodes are connected to a single control wiring line, the load capacitance of the control wiring line is large. Hence, even if the capacitance value of the variable capacitor 91 is changed, the gate voltage of the TFT 92 changes only slightly. As a result, with the circuit shown in FIG. 10, it becomes difficult to detect a change in capacitance, decreasing the sensitivity.

An object of the present invention is therefore to provide a capacitance change detecting circuit that can detect a change in capacitance with a high sensitivity and can adjust the sensitivity when used.

### Means for Solving the Problems

According to a first aspect of the present invention, there is provided a capacitance change detecting circuit that detects a change in electrostatic capacitance, the capacitance change detecting circuit including: a variable capacitance connected, at its one electrode, to a voltage supply line; a detection transistor connected, at its gate electrode, to an other electrode of the variable capacitance and outputting an electrical signal generated according to a capacitance value of the variable capacitance; and a capacitance element connected, at its one electrode, to the gate electrode of the detection transistor and connected, at its other electrode, to a control voltage line.

According to a second aspect of the present invention, in the first aspect of the present invention, an insulating film is provided on at least one of the electrodes of the variable capacitance.

According to a third aspect of the present invention, in the second aspect of the present invention, a minimum value of a distance between the electrodes of the variable capacitance is limited by the insulating film to between 0.05 mm and 0.2 mm inclusive.

According to a fourth aspect of the present invention, in the first aspect of the present invention, the capacitance change detecting circuit further includes an output control switching element that switches whether to output the electrical signal or not, the output control switching element being provided in a path of a current passing through the detection transistor.

According to a fifth aspect of the present invention, there is provided an image display device that can detect a touch position on a display screen, the image display device including: a display panel including a plurality of pixel circuits and one or more capacitance change detecting circuits; and a control circuit for the display panel, wherein each capacitance change detecting circuit includes: a variable capacitance connected, at its one electrode, to a voltage supply line; a detection transistor connected, at its gate electrode, to an other electrode of the variable capacitance and outputting an electrical signal generated according to a capacitance value of the variable capacitance; and a capacitance element connected, at its one electrode, to the gate electrode of the detection transistor and connected, at its other electrode, to a control voltage line.

### EFFECT OF THE INVENTION

According to the first aspect of the present invention, by changing a voltage applied to a control voltage line, a gate voltage of a detection transistor is suitably controlled, enabling to adjust the sensitivity of a capacitance change detecting circuit. In addition, since the control voltage line is connected to a gate electrode of the detection transistor through a capacitance element, the load capacitance of the control voltage line is small. Hence, when the capacitance value of the variable capacitor is changed, the gate voltage of the detection transistor greatly changes. Accordingly, a change in capacitance can be detected with a high sensitivity.

According to the second aspect of the present invention, by providing an insulating film on at least one of the electrodes of the variable capacitor, malfunction can be prevented which occurs when the electrodes of the variable capacitor come into contact with each other, and accordingly charge is accumulated on the gate electrode of the detection transistor.

According to the third aspect of the present invention, by providing an insulating film with a predetermined thickness on at least one of the electrodes of the variable capacitor, the minimum value of the distance between the electrodes of the variable capacitor can be limited within a range in which a change in capacitance can be detected with a high sensitivity and the sensitivity can be adjusted when used.

According to the fourth aspect of the present invention, by providing an output control switching element in a path of a current passing through the detection transistor, switching of whether to output an electrical signal or not from the capacitance change detecting circuit can be performed. By this, even when the detection transistor is not placed in a complete OFF state, the capacitance change detecting circuit can be prevented from outputting an unnecessary electrical signal.

According to the fifth aspect of the present invention, by using a capacitance change detecting circuit that can detect a change in capacitance with a high sensitivity and can adjust the sensitivity when used, an image display device can be configured that can detect a touch position on a display screen with a high sensitivity and can adjust the touch sensitivity when used.

### BRIEF DESCRIPTION OF THE DRAWINGS

FIG. 1 is a block diagram showing a configuration of a liquid crystal display device including capacitance change detecting circuits according to a first embodiment of the present invention.

FIG. 2 is a circuit diagram of a capacitance change detecting circuit according to the first embodiment of the present invention.

FIG. 3 is a cross-sectional view showing a structure of a part of the capacitance change detecting circuit shown in FIG. 2.

FIG. 4 is a characteristic diagram of the capacitance change detecting circuit shown in FIG. 2.

FIG. 5 is a characteristic diagram of the capacitance change detecting circuit shown in FIG. 2.

FIG. 6 is a block diagram showing a configuration of a liquid crystal display device including capacitance change detecting circuits according to a second embodiment of the present invention.

FIG. 7 is a circuit diagram of a capacitance change detecting circuit according to the second embodiment of the present invention.

FIG. 8 is a circuit diagram of a capacitance change detecting circuit according to a variant of the second embodiment of the present invention.

FIG. 9 is a circuit diagram of a conventional capacitance change detecting circuit.

FIG. 10 is a circuit diagram of a conventional capacitance change detecting circuit.

### MODE FOR CARRYING OUT THE INVENTION

### First Embodiment

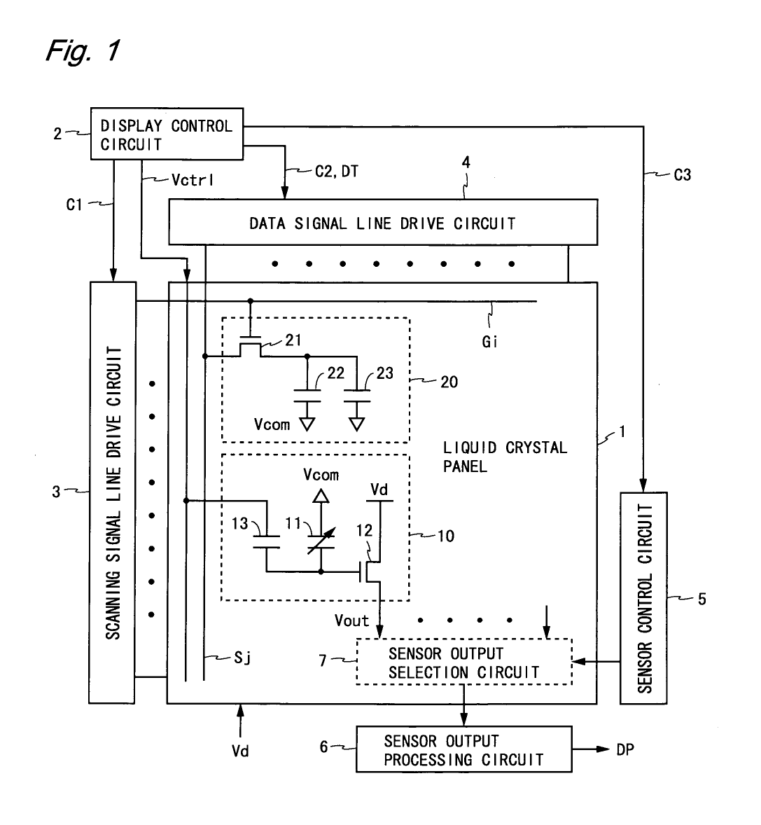

FIG. 1 is a block diagram showing a configuration of a liquid crystal display device including capacitance change detecting circuits according to a first embodiment of the present invention. The liquid crystal display device shown in FIG. 1 includes a liquid crystal panel 1, a display control circuit 2, a scanning signal line drive circuit 3, a data signal line drive circuit 4, a sensor control circuit 5, and a sensor output processing circuit 6. Capacitance change detecting circuits 10 according to the present embodiment are formed in the liquid crystal panel 1 together with pixel circuits 20, and detect changes in electrostatic capacitance caused when a surface of the liquid crystal panel 1 is pressed.

The liquid crystal panel 1 has a structure in which a liquid crystal material is sandwiched between two glass substrates. In the liquid crystal panel 1 are provided a plurality of scanning signal lines Gi parallel to one another; and a plurality of data signal lines Sj parallel to one another and intersecting perpendicularly with the scanning signal lines Gi. The pixel circuits 20 are provided near the respective intersections of the scanning signal lines Gi and the data signal lines Sj. A scanning signal line Gi is connected to those pixel circuits 20 arranged in the same row, and a data signal line Sj is connected to those pixel circuits 20 arranged in the same column. The capacitance change detecting circuits 10 are provided in association with the respective pixel circuits 20. A sensor output selection circuit 7 that selects any of the outputs from the capacitance change detecting circuits 10 is also provided in the liquid crystal panel 1.

Each pixel circuit 20 includes a TFT 21, a liquid crystal capacitance 22, and an auxiliary capacitance 23. The TFT 21 is an N-channel type MOS transistor. A gate electrode of the TFT 21 is connected to one scanning signal line Gi, a source electrode of the TFT 21 is connected to one data signal line Sj, and a drain electrode of the TFT 21 is connected to one electrode of each of the liquid crystal capacitance 22 and the auxiliary capacitance 23. The other electrode (counter electrode) of each of the liquid crystal capacitance 22 and the auxiliary capacitance 23 is connected to a voltage supply line (not shown) to which a common voltage Vcom is applied.

The display control circuit 2, the scanning signal line drive circuit 3, the data signal line drive circuit 4, and the sensor control circuit 5 are control circuits for the liquid crystal panel 1. The display control circuit 2 outputs a control signal C1 to the scanning signal line drive circuit 3, and outputs a control signal C2 and a video signal DT to the data signal line drive circuit 4. In addition, the display control circuit 2 outputs a control signal C3 to the sensor control circuit 5, and supplies a control voltage Vctr1 to the liquid crystal panel 1.

The scanning signal line drive circuit 3 selects any one of the plurality of scanning signal lines Gi according to the control signal C1, and applies a gate-on voltage (a voltage that places TFTs in an ON state) to the selected scanning signal line. The data signal line drive circuit 4 applies, according to the control signal C2, voltages generated according to the video signal DT to the data signal lines Sj. By this, pixel circuits 20 of one row are selected and voltages generated according to the video signal DT are written into the selected pixel circuits, whereby a desired image can be displayed.

The sensor control circuit 5 controls the sensor output selection circuit 7 according to the control signal C3. The sensor output selection circuit 7 selects one or more signals from among output signals from the plurality of capacitance change detecting circuits 10, according to control by the sensor control circuit 5 and outputs the selected signal (s) to the outside of the liquid crystal panel 1. The sensor output processing circuit 6 obtains position data DP representing a touch position on a display screen, based on the signal (s) outputted from the liquid crystal panel 1.

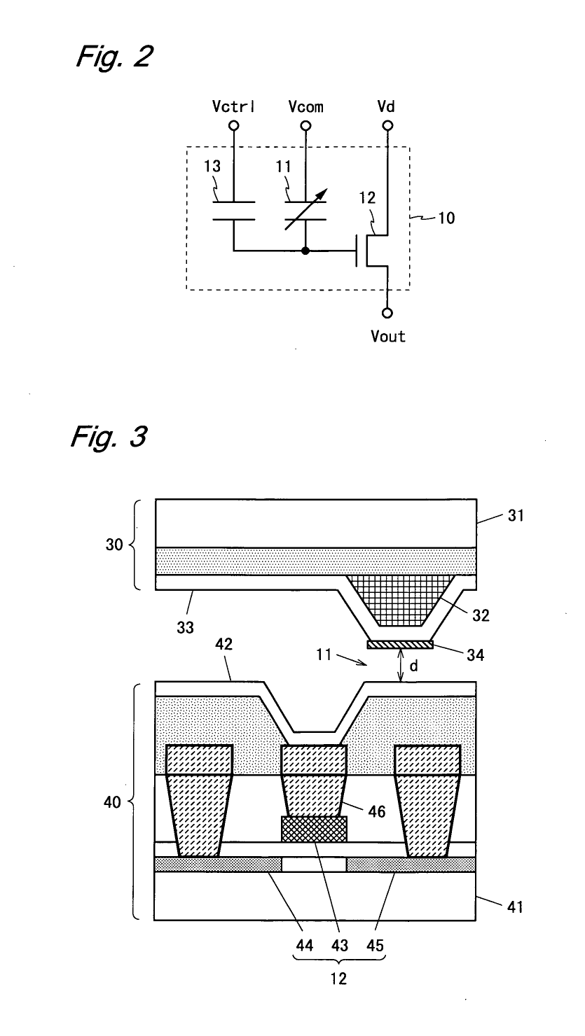

FIG. 2 is a circuit diagram of a capacitance change detecting circuit 10. As shown in FIG. 2, the capacitance change detecting circuit 10 includes a variable capacitor 11, a TFT 12, and a control capacitor 13. The TFT 12 is an N-channel type MOS transistor. One electrode of the variable capacitor 11 is connected to a voltage supply line to which a common voltage Vcom is applied, and the other electrode of the variable capacitor 11 is connected to a gate electrode of the TFT 12. A drain voltage Vd supplied from the outside of the liquid crystal panel 1 is applied to a drain electrode of the TFT 12. An output voltage Vout is outputted from a source electrode of the TFT 12. One electrode of the control capacitor 13 is connected to the gate electrode of the TFT 12, and the other electrode of the control capacitor 13 is connected to a control voltage line to which a control voltage Vctrl is applied. The TFT 12 functions as a detection transistor that outputs an electrical signal generated according to the capacitance value of the variable capacitor 11.

FIG. 3 is a cross-sectional view showing a structure of a part of the capacitance change detecting circuit 10. FIG. 3 depicts a counter substrate 30 having a counter electrode 33 formed on a glass substrate 31; and a TFT-side substrate 40 having TFTs 12, etc., formed on a glass substrate 41. A protrusion 32 is provided on one side of the counter substrate 30 (the side facing the TFT-side substrate 40; the lower side in FIG. 3), on top of which is deposited ITO (Indium Tin Oxide), thereby forming the counter electrode 33. Various circuits are formed on one side of the TFT-side substrate 40 (the side facing the counter substrate 30; the upper side in FIG. 3), on top of which is deposited ITO, thereby forming a pixel electrode and a variable capacitance electrode 42. The counter substrate 30 and the TFT-side substrate 40 are arranged facing each other, and a liquid crystal material (not shown) is filled between the two substrates. By this, a liquid crystal capacitance 22 and a variable capacitor 11 are formed. The variable capacitance electrode 42 is separated from the pixel electrode.

In a portion where the protrusion 32 is provided, the distance between the counter electrode 33 and the variable capacitance electrode 42 is shorter than that in other portions. In this portion, the variable capacitor 11 is formed. A portion of the counter electrode 33 where the protrusion 32 is provided serves as one electrode of the variable capacitor 11 (an electrode to which a common voltage Vcom is applied). A portion of the variable capacitance electrode 42 facing the portion where the protrusion 32 is provided serves as the other electrode of the variable capacitor 11.

In the TFT-side substrate 40, a TFT 12 having a gate electrode 43, a source electrode 44, and a drain electrode 45 is formed near the variable capacitor 11. The gate electrode 43 is electrically connected to the other electrode of the variable capacitor 11 through a contact 46. A common voltage Vcom is applied to the counter electrode 33. When, in this state, a surface of the counter substrate 30 is pressed with a finger, a pen, etc., the counter substrate 30 approaches the TFT-side substrate 40, reducing the distance between the electrodes of the variable capacitor 11 (a distance d shown in FIG. 3). When the distance d between the electrodes changes, the capacitance value of the variable capacitor 11 changes. Correspondingly, the gate voltage of the TFT 12 changes and the output voltage Vout also changes. Therefore, by comparing the output voltage Vout with a threshold value, it can be determined whether the liquid crystal panel 1 has been pressed or not near the variable capacitor 11.

When the counter substrate 30 approaches the TFT-side substrate 40, if the electrodes of the variable capacitor 11 come into contact with each other, then charge is accumulated on the gate electrode 43 in a floating state and accordingly the capacitance change detecting circuit 10 malfunctions. Hence, in order to prevent the electrodes of the variable capacitor 11 from coming into contact with each other, an insulating film 34 is formed so as to cover a portion of the counter electrode 33 formed in a portion where the protrusion 32 is provided. Alternatively, an insulating film may be formed so as to cover a portion of the variable capacitance electrode 42 formed in a portion facing the portion where the protrusion 32 is provided, or insulating films may be formed on both the counter electrode 33 and the variable capacitance electrode 42. Note that, when an insulating film with a thickness beyond a certain value (e.g., several tens of nanometers or more) is formed on the counter electrode 33 or the pixel electrode, the alignment property of liquid crystals is deteriorated. Hence, it is desirable that an insulating film not be formed in a display region but be formed only in the portion where the protrusion 32 is provided.

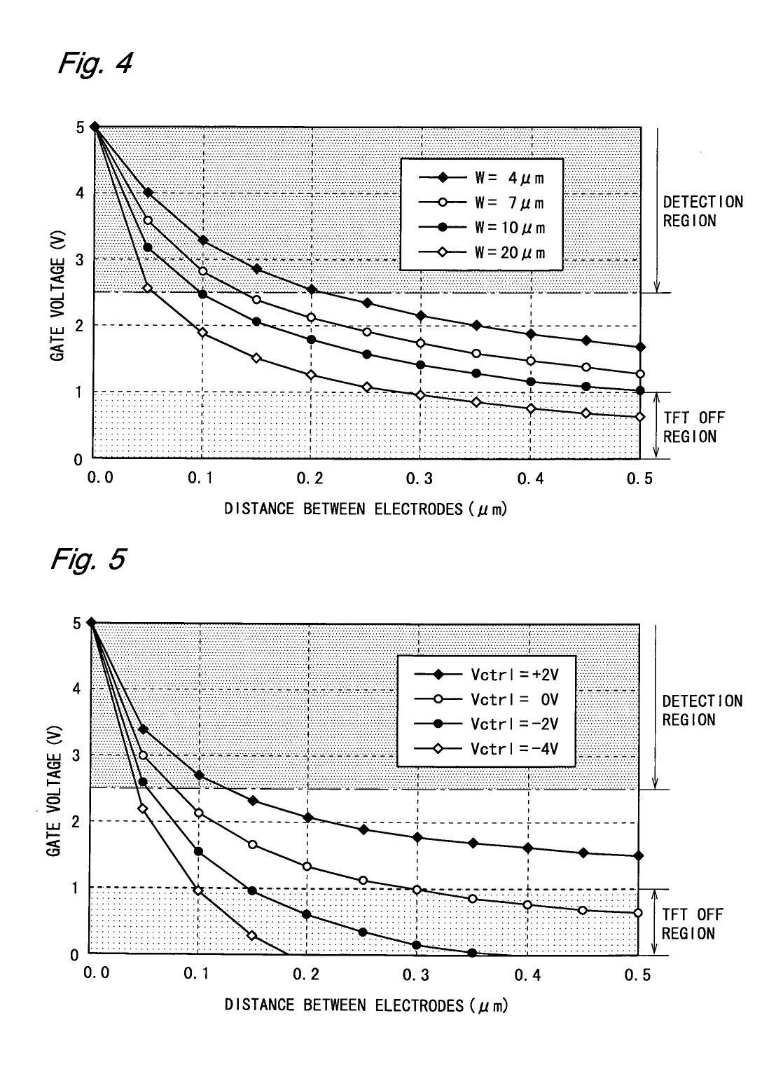

FIG. 4 is a characteristic diagram of the capacitance change detecting circuit 10. FIG. 4 depicts relationships between the distance d between the electrodes of the variable capacitor 11 and the gate voltage Vg of the TFT 12, with the common voltage Vcom being a direct current of 5 V and the channel width W of the TFT 12 being changed. As shown in FIG. 4, the smaller the distance d between the electrodes is, the higher the gate voltage Vg becomes. When the distance d between the electrodes is 0, the gate voltage Vg is equal to a common voltage of 5 V. In addition, the narrower the channel width W is, the higher the gate voltage Vg becomes.

The N-channel type TFT 12 is placed in an ON state when the gate voltage Vg is greater than or equal to a threshold voltage. However, when the gate voltage Vg is near the threshold voltage, the amount of read current flowing through the TFT 12 is small, and thus, it takes time for the output voltage Vout to change. Hence, a boundary voltage Vb higher than the threshold voltage is set and it is determined that there is a change in capacitance (i.e., the liquid crystal panel 1 has been pressed), when the gate voltage Vg is greater than or equal to the boundary voltage Vb. Here, the threshold voltage of the TFT 12 is 1 V and the boundary voltage Vb is 2.5 V. FIG. 4 depicts a range (a TFT OFF region) in which the gate voltage Vg is less than or equal to the threshold voltage, and a range (a detection region) in which the gate voltage Vg is greater than or equal to the boundary voltage. Note that 2.5 V is an example of the boundary voltage Vb and the boundary voltage Vb is arbitrarily determined according to the application, etc.

FIG. 4 depicts relationships between the distance d between the electrodes and the gate voltage Vg of the TFT 12, with the size of the TFT 12 being changed. The channel width W and channel length L of the TFT 12 are the same for all cases. An electrode of the variable capacitor 11 provided in the most protruding portion on the protrusion 32 is 4×4 μm in size.

As shown in FIG. 4, when the channel width W is 4 μm, if the distance d between the electrodes becomes less than or equal to about 0.2 μm, then it is determined that there is a change in capacitance. On the other hand, when the channel width W is 20 μm, if the distance d between the electrodes becomes less than or equal to about 0.05 μm, then it is determined that there is a change in capacitance. As such, the sensitivity of the capacitance change detecting circuit 10 changes according to the channel width W of the TFT 12.

However, the channel width W of the TFT 12 is determined when the circuit is designed, and thus, cannot be changed when the circuit is used. Hence, with the method of changing the channel width W, the sensitivity of the capacitance change detecting circuit 10 cannot be adjusted when used. To solve this problem, the capacitance change detecting circuit 10 according to the present embodiment is configured such that a control voltage Vctrl can be applied to the gate electrode of the TFT 12 through the control capacitor 13. According to such a capacitance change detecting circuit 10, by changing the control voltage Vctrl, variations in sensitivity due to changes in TFT characteristics caused by changes in process conditions can be adjusted. Also, the sensitivity can be adjusted when used.

FIG. 5 is a diagram showing the same relationships as those shown in FIG. 4, with the control voltage Vctrl being changed. The characteristics shown in FIG. 5 are obtained for a capacitance change detecting circuit 10 shown below. The electrodes of a variable capacitor 11 and a control capacitor 13 are 4×4 μm in size. The distance d between the electrodes of the variable capacitor 11 changes between 0 μm and 0.5 μm. The dielectric coefficient of the liquid crystal is 4 for an amount ε (//) in a direction parallel to the long axis of the liquid crystal, and is 7 for an amount ε (⊥) in a direction perpendicular to the long axis of the liquid crystal. The channel width and channel length of a TFT 12 are both 4 μm. The thickness of gate insulating films of the TFT 12 and the control capacitor 13 is 80 nm.

As shown in FIG. 5, when the control voltage Vctrl is +2 V, if the distance d between the electrodes becomes less than or equal to about 0.13 μm, then it is determined that there is a change in capacitance. The conditions for determining that there is a change in capacitance when the control voltage Vctrl is changed to 0 V, −2 V, and −4 V change such that the distance d between the electrodes is about 0.08 μm or less, about 0.05 μm or less, and about 0.04 μm or less. By thus changing the control voltage Vctrl, the gate voltage of the TFT 12 is suitably controlled, enabling to adjust the sensitivity of the capacitance change detecting circuit 10.

In addition, since the control voltage line to which the control voltage Vctrl is applied is connected to the gate electrode of the TFT 12 through the control capacitor 13, the load capacitance of the control voltage line is smaller than that for the conventional circuit shown in FIG. 10. Hence, when the capacitance value of the variable capacitor 11 is changed, the gate voltage of the TFT 12 greatly changes. Therefore, according to the capacitance change detecting circuit 10 according to the present embodiment, a change in capacitance caused when the surface of the liquid crystal panel 1 is pressed can be detected with a high sensitivity.

Note that, as shown in FIG. 5, when the distance d between the electrodes is 0.05 μm or less, even if the control voltage Vctrl is changed, the gate voltage Vg of the TFT 12 does not change much. Hence, to effectively make a sensitivity adjustment based on the control voltage Vctrl, it is desirable that the minimum value of the distance d between the electrodes be 0.05 μm or more. Note also that when the distance d between the electrodes is 0.2 μM or more, even if the distance d between the electrodes is changed, the gate voltage Vg of the TFT 12 does not change much. Hence, to detect a change in capacitance with a high sensitivity at all times, it is desirable that the minimum value of the distance d between the electrodes be 0.2 μm or less.

To limit the minimum value of the distance d between the electrodes to between 0.05 μm and 0.2 μm inclusive, for example, the thickness of an insulating film formed on the counter electrode 33 or the variable capacitance electrode 42 is set to between 0.05 μm and 0.2 μm inclusive. When insulating films are formed on both the counter electrode 33 and the variable capacitance electrode 42, the sum of the thicknesses of the two insulating films is made between 0.05 μm and 0.2 μm inclusive. By providing an insulating film with a predetermined thickness on at least one of the electrodes of the variable capacitor 11, the minimum value of the distance between the electrodes of the variable capacitor 11 can be limited within a range in which a change in capacitance can be detected with a high sensitivity and the sensitivity can be adjusted when used.

As described above, according to a capacitance change detecting circuit 10 according to the present embodiment, by applying a control voltage Vctrl to a gate electrode of a TFT 12 through a control capacitor 13, a change in capacitance can be detected with a high sensitivity and the sensitivity can be adjusted according to the application, person, etc., when used. In addition, by using the capacitance change detecting circuit 10, an image display device can be configured that can detect a touch position on a display screen with a high sensitivity and can adjust the touch sensitivity when used.

### Second Embodiment

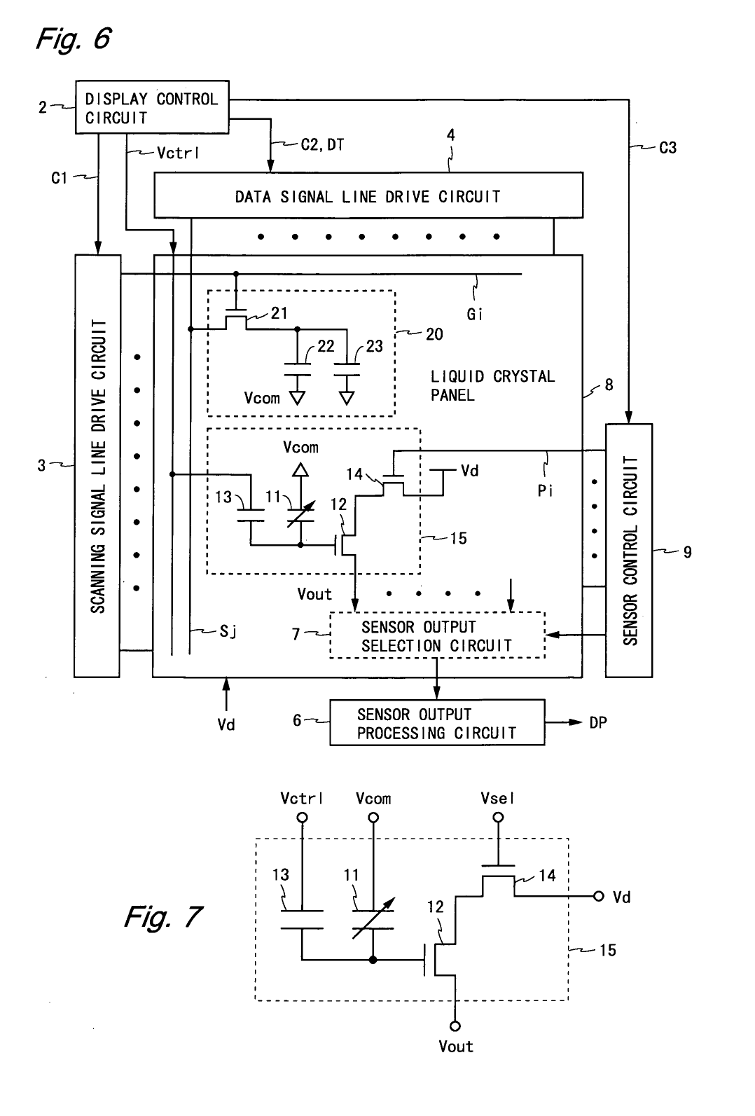

FIG. 6 is a block diagram showing a configuration of a liquid crystal display device including capacitance change detecting circuits according to a second embodiment of the present invention. The liquid crystal display device shown in FIG. 6 is such that in a liquid crystal display device according to the first embodiment (FIG. 1) a liquid crystal panel 1 and a sensor control circuit 5 are replaced by a liquid crystal panel 8 and a sensor control circuit 9. Capacitance change detecting circuits 15 according to the present embodiment are formed in the liquid crystal panel 8 together with pixel circuits 20, and detect changes in electrostatic capacitance caused when a surface of the liquid crystal panel 8 is pressed. Note that of the components in the present embodiment the same components as those in the first embodiment are denoted by the same reference numerals and description thereof is omitted.

As with the liquid crystal panel 1, in the liquid crystal panel 8 are provided a plurality of scanning signal lines Gi, a plurality of data signal lines Sj, a plurality of pixel circuits 20, a plurality of capacitance change detecting circuits 15, and a sensor output selection circuit 7. In addition to them, in the liquid crystal panel 8, row selection lines Pi of the same number as the scanning signal lines Gi are provided in parallel with the scanning signal lines Gi. A row selection line Pi is connected to those capacitance change detecting circuits 15 arranged in the same row.

As with the sensor control circuit 5, the sensor control circuit 9 controls the sensor output selection circuit 7 according to a control signal C3. In addition, the sensor control circuit 9 selects one of the plurality of row selection lines Pi according to the control signal C3, and applies a gate-on voltage to the selected row selection line. By this, capacitance change detecting circuits 15 of one row are selected and output voltages Vout can be read from the selected capacitance change detecting circuits.

FIG. 7 is a circuit diagram of a capacitance change detecting circuit 15. The capacitance change detecting circuit 15 shown in FIG. 7 is such that a TFT 14 is added to a capacitance change detecting circuit 10 according to the first embodiment (FIG. 2). The TFT 14 is an N-channel type MOS transistor. In the capacitance change detecting circuit 15, a drain electrode of a TFT 12 is connected to a source electrode of the TFT 14. A gate electrode of the TFT 14 is connected to a row selection line Pi to which a row selection voltage Vsel is applied. A drain voltage Vd supplied from the outside of the liquid crystal panel 8 is applied to a drain electrode of the TFT 14. The TFT 14 is provided in a path of a current passing through the TFT 12, and functions as an output control switching element that switches whether to output an output voltage Vout or not.

The TFT 14 is controlled to an ON state or an OFF state by the sensor control circuit 9. The capacitance change detecting circuit 15 outputs an output voltage Vout when the TFT 14 is in an ON state, and does not output an output voltage Vout when the TFT 14 is in an OFF state. As such, according to the capacitance change detecting circuit 15 according to the present embodiment, by providing the TFT 14 in the path of a current passing through the TFT 12, switching of whether to output an output voltage Vout or not can be performed.

For example, the case is considered in which, in a capacitance change detecting circuit having the characteristics shown in FIG. 5, the control voltage Vctrl is changed in a range of −4 V to +2 V. In this case, when the distance d between the electrodes is less than or equal to 0.1 μm, there is no chance that the TFT 12 is placed in a complete OFF state, regardless of the control voltage Vctrl. Hence, a leakage current flows through the TFT 12, increasing the power consumption of the capacitance change detecting circuit.

According to the capacitance change detecting circuit 15 according to the present embodiment, even when the TFT 12 is thus not placed in a complete OFF state, a leakage current can be prevented from flowing through the TFT 12 and thus an unnecessary output voltage Vout can be prevented from being outputted.

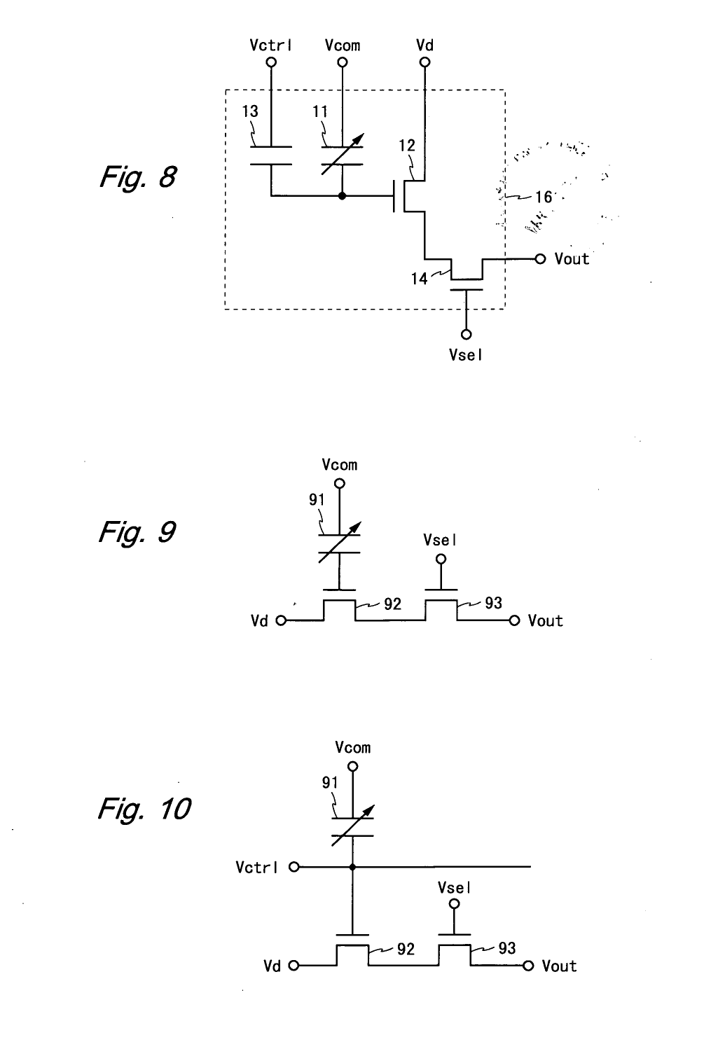

Note that, although, in the capacitance change detecting circuit 15 shown in FIG. 7, the TFT 14 is provided on the drain electrode side of the TFT 12, as shown in FIG. 8, a TFT 14 may be provided on the source electrode side of a TFT 12. In a capacitance change detecting circuit 16 shown in FIG. 8, a drain voltage Vd is applied to a drain electrode of the TFT 12, and a source electrode of the TFT 12 is connected to a drain electrode of the TFT 14. An output voltage Vout is outputted from a source electrode of the TFT 14. The capacitance change detecting circuit 16 according to this variant operates in the same manner as the capacitance change detecting circuit 15 and provides the same effects.

Note also that although, in the above description, in a liquid crystal panel a capacitance change detecting circuit is provided for every pixel circuit, in the liquid crystal panel any number of capacitance change detecting circuits may be provided in any form. For example, a capacitance change detecting circuit may be provided for every two or more pixel circuits, or a capacitance change detecting circuit may be provided only in a part of the liquid crystal panel, with no association with pixel circuits. In addition, in the liquid crystal panel, any type of wiring lines may be provided in any form as long as a necessary voltage can be supplied to the capacitance change detecting circuits and electrical signals outputted from the capacitance change detecting circuits can be outputted to the outside of the liquid crystal panel. In addition, the common voltage Vcom may be a direct-current voltage or an alternating-current voltage.

### INDUSTRIAL APPLICABILITY

Capacitance change detecting circuits of the present invention have features such as the ability to detect changes in capacitance with a high sensitivity and the ability to control the sensitivity when used. Thus, the capacitance change detecting circuits can be used in various applications where changes in capacitance are detected, such as an application where a touch position on a display screen is detected in an image display device.

### DESCRIPTION OF REFERENCE NUMERALS

1 and 8: LIQUID CRYSTAL PANEL
2: DISPLAY CONTROL CIRCUIT
3: SCANNING SIGNAL LINE DRIVE CIRCUIT
4: DATA SIGNAL LINE DRIVE CIRCUIT
5 and 9: SENSOR CONTROL CIRCUIT
6: SENSOR OUTPUT PROCESSING CIRCUIT
7: SENSOR OUTPUT SELECTION CIRCUIT
10, 15, and 16: CAPACITANCE CHANGE DETECTING CIRCUIT
11: VARIABLE CAPACITOR
12 and 14: TFT
13: CONTROL CAPACITOR
20: PIXEL CIRCUIT
30: COUNTER SUBSTRATE
31 and 41: GLASS SUBSTRATE
32: PROTRUSION
33: COUNTER ELECTRODE
34: INSULATING FILM
40: TFT-SIDE SUBSTRATE
42: VARIABLE CAPACITANCE ELECTRODE
43: GATE ELECTRODE

1. A capacitance change detecting circuit that detects a change in electrostatic capacitance, the capacitance change detecting circuit comprising:
a variable capacitor connected, at its one electrode, to a voltage supply line;
a detection transistor connected, at its gate electrode, to an other electrode of the variable capacitor and outputting an electrical signal generated according to a capacitance value of the variable capacitor; and
a capacitance element connected, at its one electrode, to the gate electrode of the detection transistor and connected, at its other electrode, to a control voltage line.

2. The capacitance change detecting circuit according to claim 1, wherein an insulating film is provided on at least one of the electrodes of the variable capacitor.

3. The capacitance change detecting circuit according to claim 2, wherein a minimum value of a distance between the electrodes of the variable capacitor is limited by the insulating film to between 0.05 μm and 0.2 μm inclusive.

4. The capacitance change detecting circuit according to claim 1, further comprising an output control switching element that switches whether to output the electrical signal or not, the output control switching element being provided in a path of a current passing through the detection transistor.

5. An image display device that can detect a touch position on a display screen, the image display device comprising:
a display panel including a plurality of pixel circuits and one or more capacitance change detecting circuits; and
a control circuit for the display panel, wherein
each capacitance change detecting circuit includes:
a variable capacitor connected, at its one electrode, to a voltage supply line;
a detection transistor connected, at its gate electrode, to an other electrode of the variable capacitor and outputting an electrical signal generated according to a capacitance value of the variable capacitor; and
a capacitance element connected, at its one electrode, to the gate electrode of the detection transistor and connected, at its other electrode, to a control voltage line.
